(19) United States
(12) Patent Application Publication
(10) Pub. No.: US 2016/0101427 A1
(43) Pub. Date: Apr. 14, 2016

(54) CLOSED-CIRCUIT GRINDING INSTALLATION

(71) Applicant: KHD HUMBOLDT WEDAG GMBH, Köln (DE)

(72) Inventors: Siegfried Strasser, Much (DE); Heide Schaefer, Bonn (DE); Oral Tueresay, Koeln (DE); Egon Scheunemann, Swisttal (DE)

(21) Appl. No.: 14/893,825

(22) PCT Filed: Sep. 20, 2013
(86) PCT No.: PCT/EP2013/069548

§ 371 Date: Nov. 24, 2015

(30) Foreign Application Priority Data
May 25, 2013 (DE) 10 2013 008 907.7

(51) Int. Cl. B02C 23/12; B02C 4/28; B02C 4/02

(52) U.S. Cl. CPC B02C 23/12; B02C 4/02; B02C 4/286

(57) ABSTRACT

A closed-circuit grinding installation for comminuting material to be ground, the grinding installation having at least one high-pressure roller press, at least one apparatus for sifting out fine material from the material to be ground which is situated within the closed circuit and at least two apparatuses for conveying the material to be ground. The at least one high-pressure roller press is arranged at a spatial distance from and approximately at the same height as the at least one apparatus for sifting out fine material from the material to be ground, wherein the at least two apparatuses for conveying the material to be ground, when viewed from the side, intersect approximately in the center of the spatial distance, wherein the spatial distance is at least between five and twenty times the width or length of the high-pressure roller press.

### CROSS-REFERENCES TO RELATED APPLICATIONS

This application claims the benefit of the German patent application No. 102013008907.7 filed on May 25, 2013, the entire disclosures of which are incorporated herein by way of reference.

### BACKGROUND OF THE INVENTION

The invention relates to a closed-circuit grinding installation for comminuting material to be ground, said closed-circuit grinding installation having at least one high-pressure roller press, at least one apparatus for sifting out fine material from the material to be ground which is circulating within the closed circuit and at least two apparatuses for conveying the material to be ground which is situated within the closed circuit. In a particular development said closed-circuit grinding installation is situated on a ship.

High-pressure presses for comminuting material to be ground were disclosed for the first time by Schönert et al. in German Disclosure DE2708053A1. High-pressure roller presses comminute material to be ground between two rollers, which rotate in opposite directions and do not exhibit any or only a small amount of slippage, by the material to be ground being pulled into a narrow roll gap between the two rollers and being processed there exclusively by means of pressure.

In a closed-circuit grinding installation, the material to be ground runs through more than one passage through the high-pressure roller press, the fine-grained to dust-like ground material being separated out from the material to be ground which is situated within the closed circuit by a corresponding apparatus for sifting out the fine material. The gravel which has not yet been sufficiently comminuted is guided, in contrast, within the closed circuit. The gravel is recirculated within the closed circuit until it is comminuted so much that it also leaves the closed-circuit grinding installation as fine-grained to dust-like ground material.

A closed-circuit grinding installation consists substantially of three main units. A first unit is the grinder, in the present case in form of a high-pressure roller press. A second unit is an apparatus for sifting out fine material and the third essential unit is an apparatus for conveying the material to be ground between the grinder and the apparatus for conveying the material to be ground which is situated within the closed circuit.

When designing usual, known closed-circuit grinding installations, it is necessary to optimize different parameters at the same time for economic use. The cost-intensive energy consumption for the comminuting process is determined for the most part by the type of grinder. The high-pressure roller press according to Schönert et al. allows for very energy-efficient comminuting because the material to be ground is sheared in the high-pressure roller press which only takes a little mechanical energy. A further parameter to be optimized is the lifting work necessary in the closed-circuit grinding installation for the material to be ground which is situated within the closed circuit. In the case of throughput rates of up to 10,000 t per day and several passages of the material to be ground, just for overcoming the height differences in the closed-circuit grinding installation a multiple of 10,000 t multiplied by the height to be overcome multiplied by the acceleration of gravity is necessary as lost conveying energy. As a result of this, attempts are made, on the one hand, to keep the speed of the material to be ground as low as possible and to avoid unnecessary circulation of fine material. On the other hand, attempts are made to keep the height differences to be overcome in the closed-circuit grinding installation as small as possible. In order to keep the lifting work as small as possible, the closed-circuit grinding installations are designed, as a rule, in a very compact manner. The compact method of construction avoids long conveying paths and large height differences. Insofar as the conveying of the fine material can also occur in a pneumatic manner, it is resorted to because forced air from other process sources, for example from the cooling of cement clinker in an installation for producing cement, is present anyhow.

Compact closed-circuit grinding installations require a very solid foundation as a result of the dead weight of the high-pressure roller press of up to 100 t and more and of the further construction with rotating parts. As closed-circuit grinding installations are frequently set up in mines or in very inaccessible locations, the construction of a sufficiently solid foundation is linked with high expenditure. The costs of a closed-circuit grinding installation are increased as a result. As a rule, it is necessary to stabilize the foundations by means of long concrete piles which reach into the earth.

### SUMMARY OF THE INVENTION

It is the object of the invention to provide a closed-circuit grinding installation which makes fewer demands on its foundation.

According to the concept of the invention, it is provided that the at least one high-pressure roller press is arranged at a spatial distance from and approximately at the same height as the at least one apparatus for sifting out fine material from the material to be ground which is situated within the closed circuit, wherein the at least two apparatuses for conveying the material to be ground which is situated within the closed circuit, when viewed from the side, intersect approximately in the center, wherein the spatial distance in a preferred manner is at least between five and twenty times the width or length of the high-pressure roller press.

The closed-circuit grinding installation as claimed in the invention deviates from the usual design up to now by a spatial distance between the grinder, in this case the high-pressure roller press, and the sifting apparatus. As a result, long conveying paths for the material to be ground which is situated within the closed circuit are consciously accepted. However, a great advantage is achieved through said accepted disadvantage. The high-pressure roller press and the sifting apparatus can be constructed in locations that are at a distance from one another such that a necessary foundation can be constructed just for the high-pressure roller press and just for the sifting apparatus. Precisely when a closed-circuit grinding installation is to be constructed at a location where a particularly solid foundation can only be set up with a very high level of expenditure, for example because a pile foundation is necessary for securing a foundation for a known closed-circuit grinding installation, the design as claimed in the invention provides the advantage that particularly solid foundations are unnecessary. Insofar as the high-pressure roller press is built in a self-supporting machine frame, it is then even acceptable when the high-pressure roller press vibrates slightly on the support or is moved slightly by means of a co-vibrating ground. There is no danger of the construction of the entire closed-circuit grinding installation being put at risk by the dynamic load of the operating high-pressure roller press.

In a development of the invention it is provided that the two apparatuses for conveying the material to be ground which is situated within the closed circuit have a gradient of between 10% and 30%, in a preferred manner of approximately between 15% and 25%. As a result of selecting the comparatively small gradient, it is possible to resort to simply constructed conveyor belts which do not have any buckets, entrainment means or shovels. In known bucket conveyors, conveyor belts with shovels or with entrainment means, wet material to be ground can be compacted such that the conveying capacity of the conveying apparatus is reduced when at the same time using an increasing amount of energy. In addition, bucket conveyors and conveyor belts with entrainment means are more maintenance-intensive, which can be a great advantage precisely when used in distant areas without good infrastructure.

In a development of the invention it is provided that a movable apparatus for feeding the material to be ground, which feeds fresh material in a selective manner onto one of the at least two apparatuses for conveying the material to be ground which is situated within the closed circuit, is situated approximately at the point of intersection between the at least two apparatuses for conveying the material to be ground which is situated within the closed circuit. The design of the closed-circuit grinding installation according to said development of the invention allows for a quick change in the material to be ground which is to be freshly supplied or in the characteristics of the material to be ground which is to be freshly supplied. Depending on the characteristics of the material to be ground, it is advantageous when, for example, moist material to be ground is dried initially in the sifting apparatus by means of hot air prior to the first passage through the high-pressure roller press. In this case, the fresh material to be ground is fed onto the conveying apparatus which leads to the sifter. However, it is also possible that the material to be ground which is to be freshly supplied should initially pass through the high-pressure roller press when, for example, the moisture of the fresh material to be ground is so high that it even supports the grinding process, for instance because vibrations of the high-pressure roller press are avoided. Other materials to be ground which tend to clump in the moist state are, in contrast, supplied first of all to the high-pressure roller press where the moist material to be ground is mixed with material to be ground that has already been pre-dried and consequently the tendency to clump is reduced. The reasons whether to supply the material to be ground either initially to the sifting apparatus or initially to the high-pressure roller press are numerous and can be decided by the expert from case to case. The arrangement of the feeding of the material to be ground at the point of intersection between the at least two conveying apparatuses consequently offers the advantage of quickly changing the configuration of the closed-circuit grinding installation.

In a preferred embodiment of the invention, it is provided that the at least one apparatus for sifting out fine material from the material to be ground which is circulating within the closed circuit has at least one V-shaped cascade sifter, wherein the V-shaped cascade shifter is arranged obliquely or even transversely to the direction of conveyance of the at least two apparatuses for conveying the material to be ground which is situated within the closed circuit.

The cascade separator used in the closed-circuit grinding installation carries out various functions. A first function is the comminuting of slugs which occur during the high-pressure processing of the material to be ground. As on a staircase, the slugs fall multiple times onto metal plates which are arranged in the manner of Venetian blinds, the slugs breaking up and upstream of the cascade separator being divided into fine material and recirculated gravel. A second function of the V-shaped cascade sifter is the separation of the fine material from the recirculated gravel in order to remove the fine material from the grinding process. As the material to be ground is not only moved vertically downward in the cascade sifter, but is also progressed in a horizontal manner when moving over the Venetian-blind-like plates, the alignment obliquely or transversely to the conveying direction of the at least two conveying devices is advantageous because, as a result, the intersecting conveying devices can be arranged spatially such that they do not collide at the point of intersection.

In a particular development of the invention it is provided that the vertical centers of the inlet and outlet of the at least one high-pressure roller press and of the at least one apparatus for sifting out fine material from the material to be ground which is circulating within the closed circuit are situated approximately at the same height. Said alignment of the inlet and outlet, which does not necessarily go along with the ideal alignment with reference to as small an amount of lifting work as possible for the material to be ground which is situated within the closed circuit, allows for the arrangement on a ship.

In a special development, the closed-circuit grinding installation as claimed in the invention is constructed on a ship or on a floating pontoon. It can be economically advantageous to convey the grinding material to be comminuted from its site of removal, from the mine or quarry, to a berth of the ship or of the pontoon with the closed-circuit grinding installation in order to comminute the material to be ground there on the ship or pontoon and to transport the ground material back again to wherever it will be processed further. The grinding installation constructed on a ship allows for the mobile use of the closed-circuit grinding installation. The alignment described beforehand of the at least one high-pressure roller press and of the at least one apparatus for sifting out fine material makes it possible for the ship to be trimmed meticulously as the foundation for the closed-circuit grinding installation. The height of the center of gravity of the individual units, in this case, is less important to the operation of the closed-circuit grinding installation than for the conveying of the closed-circuit grinding installation with the motion of the sea. The design as claimed in the invention also makes it possible for the weight of the closed-circuit grinding installation on the ship to be distributed over the length of the ship. In a preferred development, in this case, it is provided that the at least one high-pressure roller press is arranged in the aft third or on the boundary between the aft third and the center third of the length of the ship, where a ship, as a rule, is constructed in a more sturdy manner as a result of the position of the heavy marine engine and ships as a rule being designed such that in the case of a pitching or yawing movement in the motion of the sea they rotate about one point which lies on the boundary between the aft third of the length of the ship and the center third of the length of the ship. The lateral movements or the spatial offset in the case of the motion of the sea are the shortest at said point, as a result of which small linear accelerations prevail there. The small linear accelerations are advantageous for the use of the, as a rule, very heavy high-pressure roller press on a ship as the anchoring means of the high-pressure roller press in the ship are not loaded too strongly by the motion of the sea.

In a further advantageous development of the invention, it is provided that the at least one apparatus for sifting out fine material from the material to be ground which is circulating within the closed circuit is arranged in the forward third of the ship. Said preferred design allows for the storage of ground material or of fresh material between the at least one high-pressure roller press in the aft third of the length of the ship and the at least one apparatus for sifting out fine material from the material to be ground which is circulating within the closed circuit in the forward third of the length of the ship such that the ship or the pontoon is evenly loaded even when the closed-circuit grinding installation is operating.

As the units of the closed-circuit grinding installation have a comparatively high density and consequently can seriously already change the trim of the ship if the position of the units on a ship is changed slightly, it is provided in a further advantageous development of the invention that the centers of gravity of the at least one high-pressure roller press and of the at least one apparatus for sifting out fine material from the material to be ground which is circulating within the closed circuit are situated in the centerline of the ship. The alignment in the centerline of the ship allows the ship to carry out a rolling movement with the motion of the sea without the rolling movement causing the ship or the pontoon to exhibit a dangerous skew position a list which influences the ship when it travels straight ahead.

In a particular development of the closed-circuit grinding installation as claimed in the invention it is provided that at least two apparatuses for conveying the material to be ground which is situated within the closed circuit are surrounded by an enclosure. The enclosure allows for the conveying of hot or heated material to be ground such that the drying heat is not lost too quickly to the surrounding air. In addition, the material to be ground does not become unnecessarily moist when being conveyed in the rain. Finally, the enclosure avoids the fine, dust-like ground material being blown away when it is being conveyed from the high-pressure roller press to the sifter.

### BRIEF DESCRIPTION OF THE DRAWINGS

The invention is explained by way of the following figures, in which, in detail:

FIG. 1 shows a side view of the closed-circuit grinding installation as claimed in the invention,

FIG. 2 shows the closed-circuit grinding installation according to FIG. 1 with a right-angled triangle arrangement viewed from above,

FIG. 3 shows the closed-circuit grinding installation according to FIG. 1 with an isosceles triangle arrangement viewed from above,

FIG. 4 shows a view from the side of a closed-circuit grinding installation as claimed in the invention in an indicated body of a ship,

FIG. 5 shows a view from above of a closed-circuit grinding installation as claimed in the invention according to FIG. 2 in the body of a ship,

FIG. 6 shows a view from above of a closed-circuit grinding installation as claimed in the invention according to FIG. 3 in the body of a ship,

FIG. 7 shows a view from the side of a closed-circuit grinding installation as claimed in the invention with three apparatuses for conveying,

FIG. 8 shows a view from above of the closed-circuit grinding installation as claimed in the invention according to FIG. 7.

### DETAILED DESCRIPTION OF THE PREFERRED EMBODIMENTS

FIG. 1 outlines a view from the side of a closed-circuit grinding installation 1 as claimed in the invention with three essential units. The essential units are a high-pressure roller press 2, an apparatus for sifting 3 fine material from the material to be ground 4 which is situated within the closed circuit and two apparatuses for conveying 5.1 and 5.2 the material to be ground 4 which is situated within the closed circuit. As claimed in the invention, it is provided that the high-pressure roller press 2 is at a distance from the apparatus for sifting 3 fine material out of the material to be ground 4 which is situated within the closed circuit. The connection between the two units is provided by means of the two apparatuses for conveying 5.1 and 5.2 which are outlined in FIG. 1. Said apparatuses convey the material to be ground 4 in each case in an ascending manner from in each case one unit to the respective other unit such that the closed circuit of the material to be ground is created between the high-pressure roller press 2 and the apparatus for sifting 3. Fine ground material 4 is removed from the closed circuit by means of the apparatus for sifting 3 and fresh, rough material to be ground is added into the closed-circuit grinding installation 1 by feeding onto the high-pressure roller press 3, by feeding onto the apparatus for sifting 3 and/or by feeding onto the apparatuses for conveying 5.1 and 5.2 in the closed circuit.

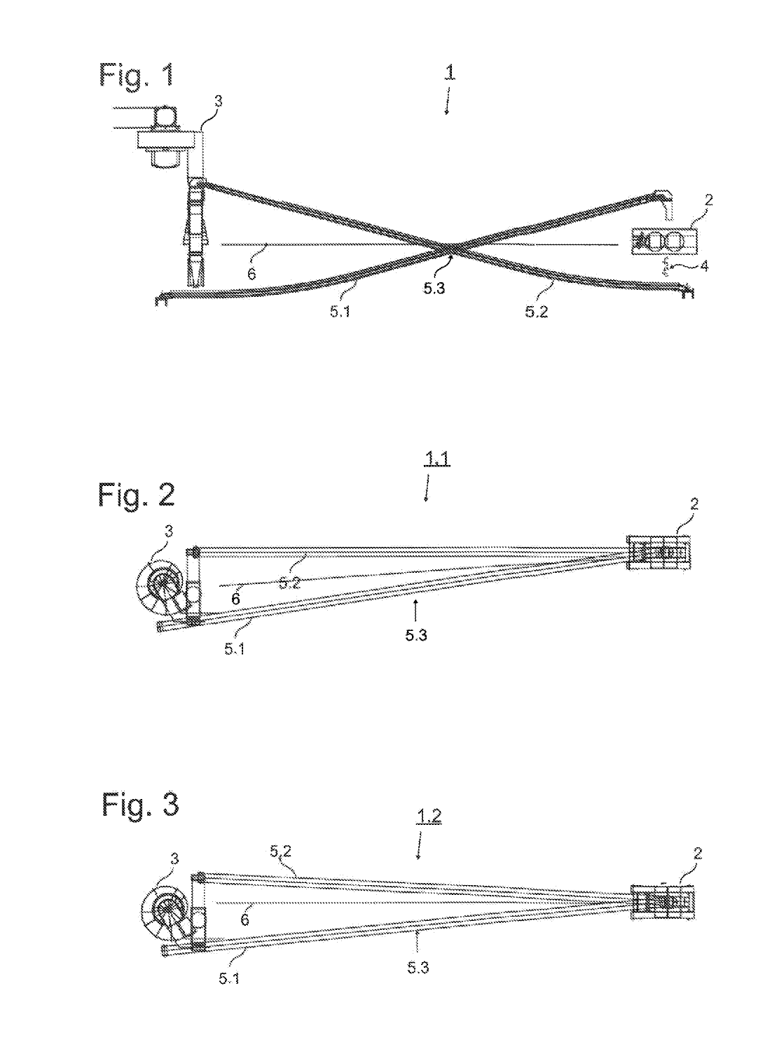

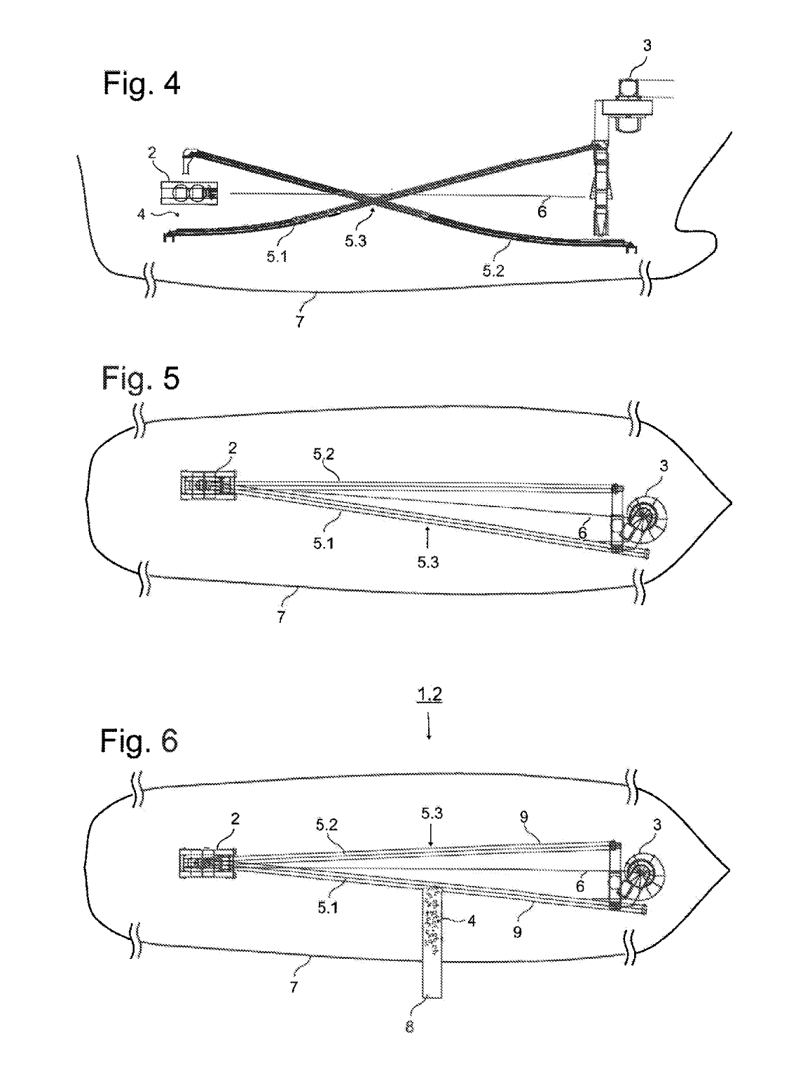

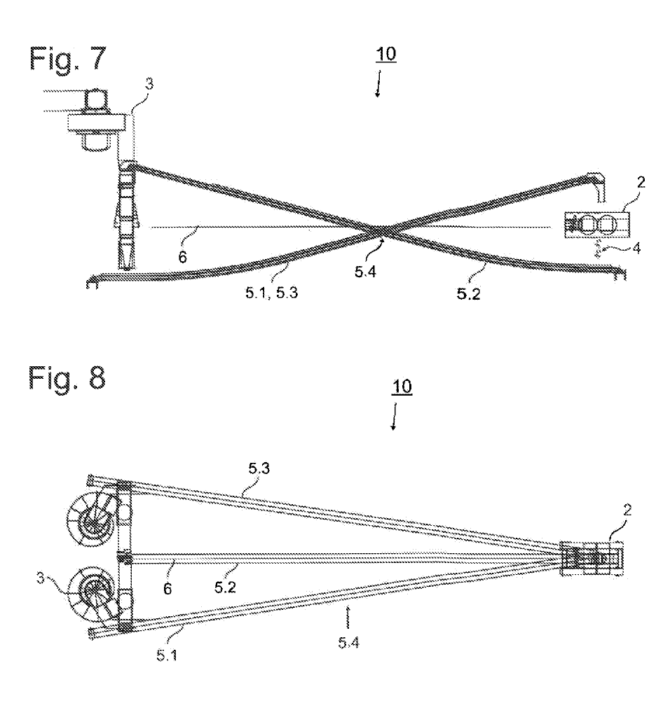

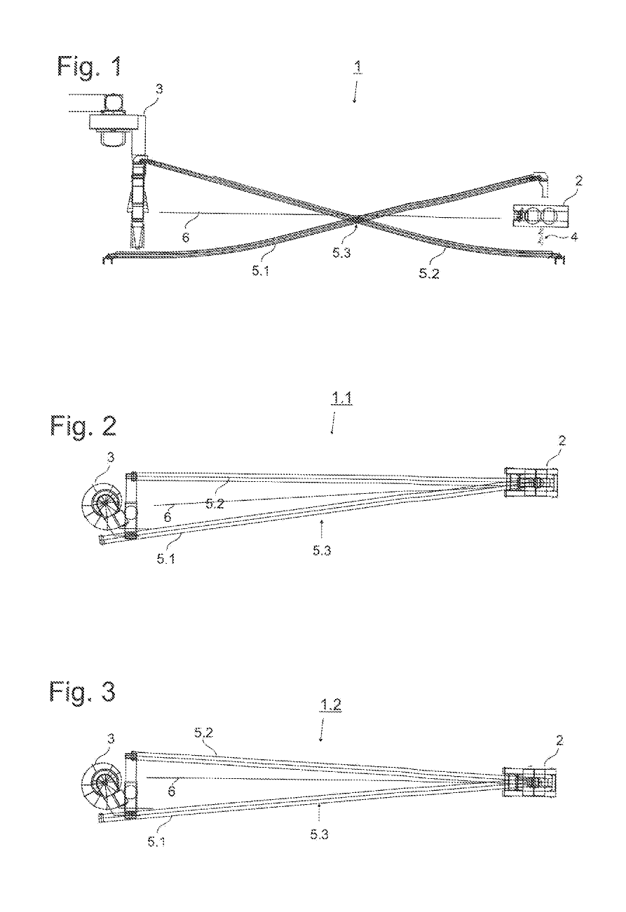

FIG. 2 shows a view from above of the closed-circuit grinding installation 1 in a first configuration 1.1. In said configuration 1.1 the apparatuses for conveying 5.1 and 5.2 are arranged in the form of a right-angled triangle. The material to be ground passes through the high-pressure roller press in the vertical direction. Consequently, the apparatuses for conveying 5.1 and 5.2 overlap one another at said location. The ground material passes through the apparatus for sifting 3 not only in the vertical but also with a horizontal directional component. In order to compensate for the lateral offset, the apparatus for conveying 5.1 is set in an oblique manner. In said configuration 1.1, the line of symmetry of the high-pressure roller press 2 does not coincide with the distance line 6 between the two units of the high-pressure roller press 2 and the apparatus for sifting 3. In the case of an arrangement on aligned foundations, said configuration 1.1 could generate unnecessary difficulties for the fastening on the respective foundation.

In order to simplify the arrangement on aligned foundations, it is consequently provided in a further configuration 1.2 shown in FIG. 3 that the closed-circuit grinding installation 1, when viewed from above, is arranged in a symmetrical manner such that the two apparatuses for conveying 5.1 and 5.2 form an isosceles triangle. Said configuration 1.2 simplifies the construction on, as a rule, aligned foundations.

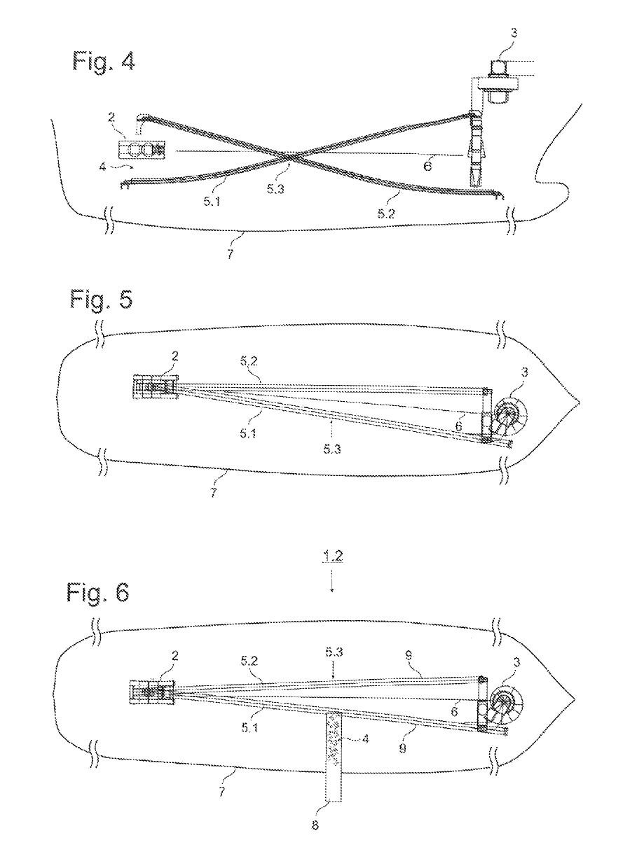

FIG. 4 outlines how the closed-circuit grinding installation 1 is arranged in a body of a ship 7. In this case, a silhouette of the body of the ship 7 is drawn from the side. The position of the heavy high-pressure roller press 2 is arranged in an ideal manner approximately on the boundary between the aft third and center third of the length of the ship. However, the ideal location varies with the actual design of the hull of the ship. Many ships are capable of absorbing heavy loads at the specified location. As a result of the spacing as claimed in the invention between the high-pressure roller press 2 and the apparatus for sifting 3, it is possible to distribute the weight of the closed-circuit grinding installation in the hull 7 of the ship in an ideal manner. It is possible to accommodate material to be ground, fine material, but also further secondary units such as a blower, a dust separator and silos, between the high-pressure roller press 2 and the apparatus for sifting 3.

FIG. 5 shows a view from above into the hull of the ship of the configuration 1.1 from FIG. 2. The asymmetric design makes it necessary to arrange the heavy high-pressure roller press 2 and the apparatus for sifting 3 in an angular manner so that the center of gravity thereof is arranged in the centerline of the ship. In the case of the oblique arrangement, difficulties can arise regarding the stable arrangement inside the hull 7 of the ship depending on the type of the hull of the ship.

In order to achieve as symmetrical an arrangement as possible in the hull of the ship for the ideal weight distribution, FIG. 6 shows the symmetrical arrangement in a hull 7 of a ship according to configuration 1.2 from FIG. 3. In said arrangement of the units, the high-pressure roller press 2 is aligned in the longitudinal direction of the hull 7 of the ship with its own longitudinal direction of the high-pressure roller press 2. The apparatus for sifting 3, in contrast, is aligned transversely with respect to the longitudinal direction of the hull 7 of the ship in order to avoid a collision between the apparatuses for conveying 5.1 and 5.2 in the space. In order to feed material to be ground 4 in an alternating manner onto the one or onto the other conveyor belt, it is provided that fresh material to be ground 4 is fed by way of a movable apparatus for feeding material to be ground 8 approximately in the center at the vertical point of intersection 5.4 between the two apparatuses for conveying 5.1 and 5.2. In order to avoid dust blowing off from the apparatuses for conveying 5.1 and 5.2 in an unwanted manner, the apparatuses for conveying 5.1 and 5.2 are enclosed in a preferred manner by means of an enclosure 9.

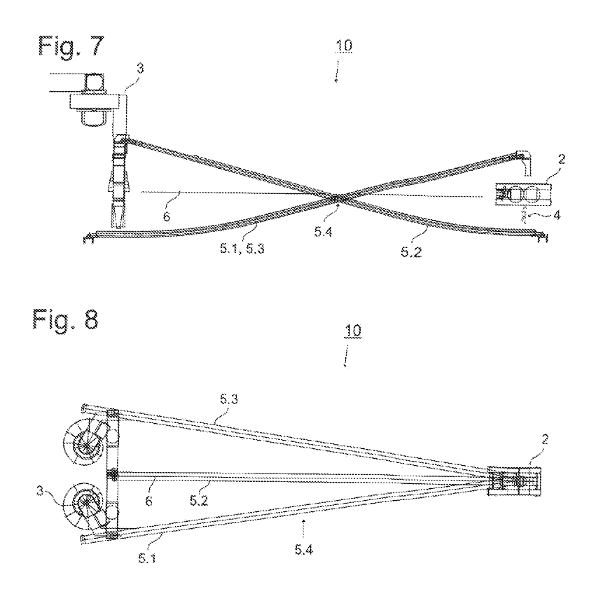

FIG. 7 shows a particular development of the closed-circuit grinding installation as claimed in the invention. As a result of the side view, said outline shown in FIG. 7 does not differ from the outline shown in FIG. 1. However, two apparatuses for sifting 3 and 3.1, which are present in said view precisely one behind the other, are situated in said closed-circuit grinding installation 10. The gravel which is conveyed back to the high-pressure roller press 2 within the closed circuit is conveyed back to the high-pressure roller press 2 correspondingly by means of two apparatuses for conveying, which are also shown precisely one behind the other in said outline in FIG. 7.

FIG. 8 shows a view from above of the configuration of the closed-circuit grinding installation 10 from FIG. 7. It is provided for closed-circuit grinding installations 10 with a very high throughput that two apparatuses for sifting 3 and 3.1 are present, the gravel from a high-pressure roller press 2 being conveyed into said apparatuses together by means of an apparatus for conveying 5.2. The gravel conveyed out of the high-pressure roller press is then sifted in the two apparatuses for sifting 3 and 3.1 and the gravel sifted out from the two apparatuses for sifting is then conveyed back to the high-pressure roller press by means of each apparatus for conveying 5.1 and 5.3. In said configuration of the closed-circuit grinding installation, the two apparatuses for conveying 5.1 and 5.3 extend along the entire path approximately parallel to one another. However, the apparatus for conveying 5.2, which conveys the material to be ground out of the high-pressure roller press 2 to the apparatuses for sifting, intersects the two other apparatuses for conveying 5.1 and 5.2 such that the at least two apparatuses for conveying 5.1, 5.3 the material to be ground 4 which is situated within the closed circuit and the apparatus for conveying 5.2 the material to be ground 4 which is situated within the closed circuit, when viewed from the side, intersect approximately in the center, the spatial distance between the high-pressure roller press 2 and the apparatus for sifting 3 and 3.1 in a preferred manner being at least between five and twenty time the width or length of the high-pressure roller press 2.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-10. (canceled)

11. A closed-circuit grinding installation for comminuting material to be ground, comprising:
at least one high-pressure roller press,
at least one apparatus for sifting out fine material from the material to be ground which is situated within the closed circuit,
at least two apparatuses for conveying the material to be ground which is situated within the closed circuit,
the at least one high-pressure roller press being arranged at a spatial distance from and approximately at the same height as the at least one apparatus for sifting out fine material from the material to be ground which is situated within the closed circuit,
the at least two apparatuses for conveying the material to be ground which is situated within the closed circuit, when viewed from the side, intersect approximately in the center of the spatial distance, and
the spatial distance is at least five times one of a width or length of the high-pressure roller press, and
the at least one apparatus for sifting out fine material from the material to be ground which is circulating within the closed circuit has at least one V-shaped cascade sifter, wherein the V-shaped cascade sifter is arranged transversely to the direction of conveyance of the at least two apparatuses for conveying the material to be ground which is situated within the closed circuit.

12. The closed-circuit grinding installation according to claim 11, wherein the spatial distance is at least 20 times one of the width or length of the high-pressure roller press.

13. A closed-circuit grinding installation for comminuting material to be ground, comprising:
at least one high-pressure roller press,
at least one apparatus for sifting out fine material from the material to be ground which is situated within the closed circuit,
at least two apparatuses for conveying the material to be ground which is situated within the closed circuit,
the at least one high-pressure roller press being arranged at a spatial distance from and approximately at the same height as the at least one apparatus for sifting out fine material from the material to be ground which is situated within the closed circuit,
the at least two apparatuses for conveying the material to be ground which is situated within the closed circuit, when viewed from the side, intersect approximately in the center of the spatial distance, and
the spatial distance being at least five times one of a width or length of the high-pressure roller press, and
the closed-circuit grinding installation being constructed in a ship, wherein the at least one high-pressure roller press is arranged in an aft third of the ship or on a boundary between the aft third and a center third of the ship.

14. The closed-circuit gringing installation according to claim 13, wherein the spatial distance is at least 20 times one of the width or length of the high-pressure roller press.

15. A closed-circuit grinding installation for comminuting material to be ground, said closed-circuit grinding installation comprising:
at least one high-pressure roller press,
at least one apparatus for sifting out fine material from the material to be ground which is situated within the closed circuit,
at least two apparatuses for conveying the material to be ground which is situated within the closed circuit,
the at least one high-pressure roller press being arranged at a spatial distance from and approximately at the same height as the at least one apparatus for sifting out fine material from the material to be ground which is situated within the closed circuit,
wherein the at least two apparatuses for conveying the material to be ground which is situated within the closed circuit, when viewed from the side, intersect approximately in the center, and
wherein the spatial distance is at least five times one of the width or length of the high-pressure roller press, and
wherein a movable apparatus for feeding the material to be ground, which feeds fresh material in a selective manner onto one of the at least two apparatuses for conveying the material to be ground which is situated within the closed circuit, is situated approximately at a point of intersection between the at least two apparatuses for conveying the material to be ground which is situated within the closed circuit.

16. The closed-circuit grinding installation according to claim 15, wherein the spatial distance is at least 20 times one of the width or length of the high-pressure roller press.

17. The closed-circuit grinding installation as claimed in claim 11, wherein the two apparatuses for conveying the material to be ground which is situated within the closed circuit have a gradient of between 10% and 30%.

18. The closed-circuit grinding installation according to claim 17, wherein the gradient is between approximately 17% and 23%.

19. The closed-circuit grinding installation as claimed in claim 11, wherein a movable apparatus for feeding the material to be ground, which feeds fresh material in a selective manner onto one of the at least two apparatuses for conveying the material to be ground which is situated within the closed circuit, is situated approximately at a point of intersection between the at least two apparatuses for conveying the material to be ground which is situated within the closed circuit.

20. The closed-circuit grinding installation as claimed in claim 11, wherein the vertical centers of the inlet and outlet of the at least one high-pressure roller press and of the at least one apparatus for sifting out fine material from the material to be ground which is circulating within the closed circuit are situated approximately at the same height.

21. The closed-circuit grinding installation as claimed in claim 13, wherein a movable apparatus for feeding the material to be ground, which feeds fresh material in a selective manner onto one of the at least two apparatuses for conveying the material to be ground which is situated within the closed circuit, is situated approximately at a point of intersection between the at least two apparatuses for conveying the material to be ground which is situated within the closed circuit.

22. The closed-circuit grinding installation as claimed in claim 21, wherein the at least one apparatus for sifting out fine material from the material to be ground which is circulating within the closed circuit is arranged in a forward third of the ship.

23. The closed-circuit grinding installation as claimed in claim 21, wherein the vertical centers of the inlet and outlet of the at least one high-pressure roller press and of the at least one apparatus for sifting out fine material from the material to be ground which is circulating within the closed circuit are situated approximately at the same height.

24. The closed-circuit grinding installation as claimed in claim 23, wherein the centers of gravity of the at least one high-pressure roller press and of the at least one apparatus for sifting out fine material from the material to be ground which is circulating within the closed circuit are situated in the centerline of the ship in the longitudinal direction.

25. The closed-circuit grinding installation as claimed in claim 20, wherein at least two apparatuses for conveying the material to be ground which is situated within the closed circuit are surrounded by an enclosure.
